(19) United States
(12) Patent Application Publication
(10) Pub. No.: US 2013/0346223 A1
(43) Pub. Date: Dec. 26, 2013

(54) PROCESSING POINT-OF-SALE TRANSACTIONS USING A MOBILE CARD AND MOBILE PHONE

(71) Applicants: Rajen S. Prabhu, Singapore (SG); David Chan, Singapore (SG)

(72) Inventors: Rajen S. Prabhu, Singapore (SG); David Chan, Singapore (SG)

(21) Appl. No.: 13/533,005

(22) Filed: Jun. 26, 2012

(51) Int. Cl. G06Q 20/20; G06Q 20/32; G06Q 20/34; G06Q 20/40

(52) U.S. Cl. 705/17; 705/21

(57) ABSTRACT

In some example embodiments, a mobile card is determined to have been presented as payment in a point-of-sale (POS) transaction and a mobile phone is determined to be associated with the mobile card. A transaction request is then sent to a mobile phone and a transaction authorization is received from the mobile phone. The POS transaction is then authorized.

### FIELD

The present invention relates to processing point-of-sale (POS) transactions. In particular, the present invention relates to systems and methods for processing a POS transaction using a mobile card and a mobile phone.

### BACKGROUND

Payment cards, such as credit card, debit cards, and gift card, are ubiquitous. For decades, such payment cards have included an account number that is printed or embossed on the payment card, along with a magnetic stripe in which the account number is stored. More recently, account numbers have also been stored in a radio frequency identification (RFID) integrated circuit (IC) embedded in the payment card. To finalize a purchase transaction with a payment card, the payment card is swiped through a magnetic stripe reader or tapped on a proximity reader that are both integrated into a POS device. The readers read the account number from the magnetic stripe or the RFID IC. The account number is then used to route a transaction authorization request that is initiated by the POS device.

Unfortunately, the ease and convenience of payment card transactions has resulted various types of related theft and fraud. For example, when a payment card is lost or stolen, it remains active until the card holder notifies the issuer that the payment card has been lost. Thus, until the card holder realizes that the payment card has been lost and notifies the payment card issuer, an unauthorized user may make purchases using the payment card.

One common security measure on payment cards to prevent fraudulent use is a signature panel. The signature panel is generally employed by merchants to compare the signature on the panel with the signature of the card holder. Unfortunately, signatures are relatively easy to forge and relatively difficult to compare. Further, self-serve POS devices, such as those commonly employed at gas station pumps and kiosks, are common targets for stolen payment cards, as there is no way to verify the card holder's identity.

Another common security measure on payment cards is a printed or embossed name of the authorized card holder. Merchants can use this name by comparing it to a government issued identification card that includes a photo of the holder, such as a government issued driver's license card for example, to thereby confirm that the user presenting the payment card is in fact the authorized user of the payment card. Regrettably, however, fraudulent photo identification cards are increasingly common. Further, the self-serve POS devices discussed above are not generally equipped to verify the identity of the user presenting the payment card.

It would be desirable to provide systems and methods that would allow for an authorized user of a payment card additional security when using the payment card in a POS transaction.

### BRIEF DESCRIPTION OF THE DRAWINGS

FIG. 1 is a block diagram representation of a system that may be provided according to some embodiments.

FIGS. 2A and 2B illustrate front and back sides of an example mobile card that may be used according to some embodiments;

FIG. 3 is a chart that illustrates a data record that associates a mobile card with a mobile phone and with a mobile wallet account.

FIGS. 4A and 4B are a flow chart that illustrates a method that may be performed according to some embodiments.

FIGS. 5A and 5B illustrate example screen displays that may be presented to a user on a mobile phone according to some embodiments.

### DETAILED DESCRIPTION

To alleviate problems inherent in the prior art, the present invention introduces systems and methods for processing a point-of-sale (POS) transaction using a mobile card and a mobile phone.

Some embodiments of the present invention are associated with a “user” who is an authorized user of a mobile card and a mobile phone. As used herein, the term “user” might refer to, for example, a person who is capable of presenting a mobile card as payment in a POS transaction and also capable of engaging with a mobile phone to authorize the transaction. As used herein, the term “mobile card” might refer to, for example, a payment card that is capable of storing card information that can be automatically retrieved using a POS device. The term “POS device” might refer to, for example, a POS terminal capable of automatically retrieving information from a payment card. Thus, a “POS device” may include a payment card reader that is configured as an attachment to a mobile phone that enables the mobile phone to automatically retrieve card information from a payment card. As used herein, the term “mobile wallet account” might refer to, for example, any account capable of being associated with a mobile card, such as a credit account, a deposit account, a prepaid payment card account, or a frequent flyer account. These and other terms will be used to describe features of some embodiments of the present invention by reference to the following detailed description of some example embodiments, the appended claims and the drawings provided herewith.

For purposes of illustrating features of some embodiments of the present invention, a simple illustrative example will now be introduced and referenced throughout the disclosure. In the illustrative example, a user (named “John Doe”) is physically present at a brick-and-mortar store of a merchant named Benjamin's Shoes and has selected a pair of men's shoes to purchase that cost $215.99. At the checkout counter of Shoe Store, John Doe presents the pair of men's shoes to the cashier along with a mobile card as payment for the men's shoes. John Doe is an authorized user of the mobile card. John Doe is also carrying a mobile phone of which John Doe is an authorized user and that is associated with the mobile card. Those skilled in the art will recognize that this example is illustrative and not limiting and is provided purely for explanatory purposes.

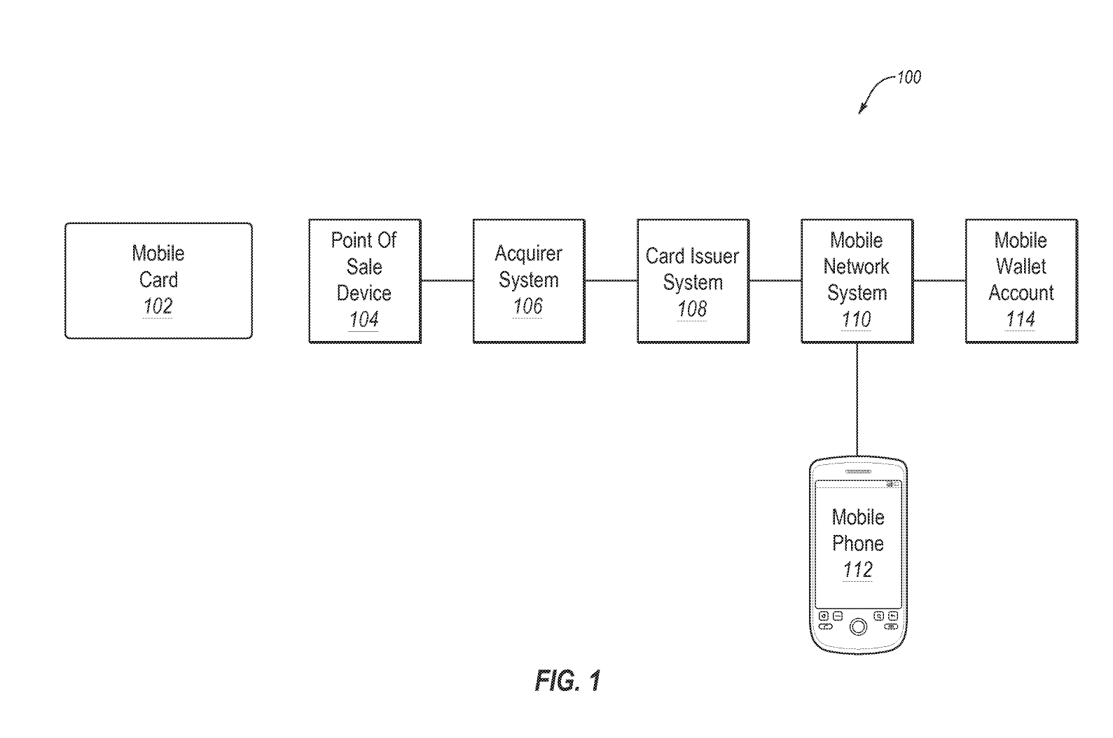

Turning now in detail to the drawings, FIG. 1 is a block diagram representation of a system 100 that may be provided according to some embodiments. The system 100 includes a mobile card 102, a POS device 104, an acquirer system 106, a card issuer system 108, a mobile network system 110, a mobile phone 112, and a mobile wallet account 114. Each of the POS device 104, acquirer system 106, card issuer system 108, mobile network system 110, and mobile phone 112 may include or have access to one or more processors and one or more storage devices. Each storage device may include any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices, for example. The storage devices may store programs for controlling the processors. The programs may be stored in a compressed, uncompressed, compiled, uncompiled, encrypted, and/or unencrypted format. The programs may furthermore include other program elements, such as an operating system, a database management system, and/or device drivers used by the processors to interface with peripheral devices. The processors perform instructions of the programs stored in the storage devices, and thereby operate in accordance with the present invention. Note that the processors and storage device may be co-located with, or remote from, the POS device 104, acquirer system 106, card issuer system 108, mobile network system 110, and mobile phone 112.

The system 100 also includes communication networks, represented by the lines between the device 104 and the system 106, between the systems 106-110, between the system 110 and the mobile phone 112, and between the system 110 and the mobile wallet account 114. The communication networks may include, for example, a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a cellular communication network, an Internet Protocol (IP) network such as the Internet, or some combination thereof. Moreover, as used herein, network communications include those enabled by wired or wireless technology. Although a limited number of communication networks are shown in FIG. 1, any number of such networks may be included in the system 100. Similarly, any number of the other devices described herein may be included in the system 100 according to embodiments of the present invention.

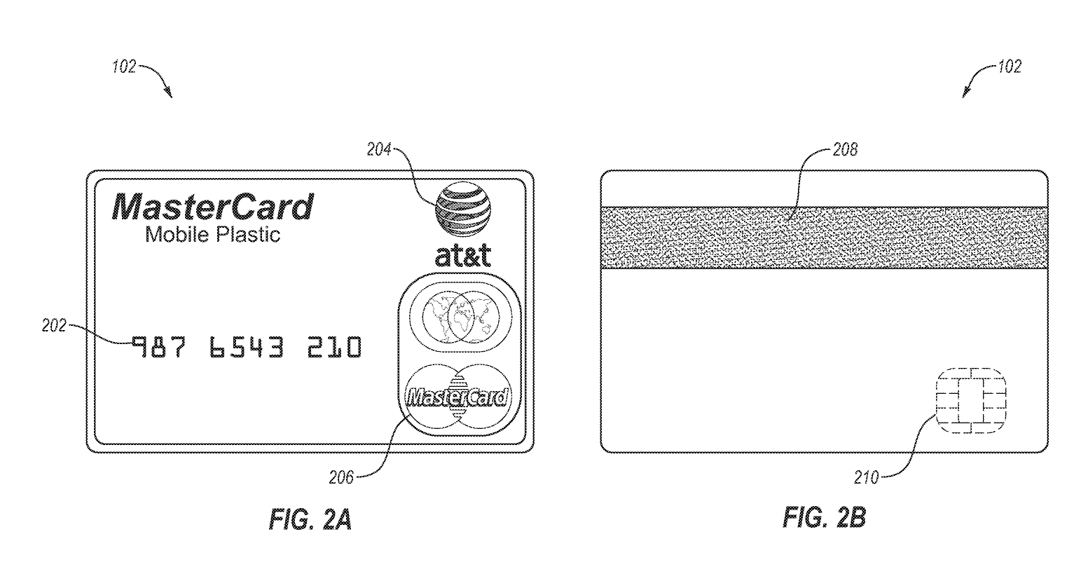

When used in combination with the mobile phone 112 and the mobile wallet account 114, the mobile card 102 is configured to be accepted as payment in a POS transaction. The mobile card 102 may have the form factor of a traditional plastic payment card. For example, FIGS. 2A and 2B show front and back sides of an example mobile card 102. The mobile card 102 includes a serial number 202 and logos 204 and 206 printed on the front side of the mobile card 102. The serial number 202 uniquely identifies the mobile card 102 and thus distinguishes the mobile card 102 from all other mobile cards (not shown). The logo 204 is a logo of a mobile network, also known as a mobile network operator (MNO), associated with the mobile phone 112. The logo 206 is a logo of a card issuer of the mobile card 102. These logos may match similar logos displayed at merchants to enable the user to identify merchants that will accept the mobile card 102 as payment.

The mobile card 102 may also include a magnetic stripe 208 and/or a radio frequency identification (RFID) integrated circuit (IC) 210 embedded in the mobile card. In at least some example embodiments, the magnetic stripe 208 and/or RFID IC 210 can store card information. For example, the card information may include the serial number 202 that is printed on the front side of the mobile card 102, a bank identification number (BIN) associated with the mobile network system 110, and potentially other routing information. For example, the BIN may be a six-digit BIN, the serial number may be a ten-digit serial number, and the routing information may include information concerning the card issuer and the mobile network associated with the mobile card 102, for example.

In the example embodiment disclosed in FIGS. 2A and 2B, having the serial number 202 visible on the mobile card 102 but the BIN and any other routing information not visible on the mobile card 102 avoids the full card information from being obtained visually by an unauthorized user. Further, not printing the actual account number associated with the mobile card 102 avoids the fraudulent procurement of a usable account number by simply viewing the mobile card 102. To discourage any attempt use of the mobile card 102 prior to activation, the mobile card 102 may include a message printed thereon that states that the mobile card 102 cannot be used to make a payment without first being associated with a mobile wallet account. To discourage any attempt to use the mobile card 102 without the associated mobile phone 112, the mobile card 102 may further include a message printed thereon that the mobile card 102 is not a payment instrument by itself.

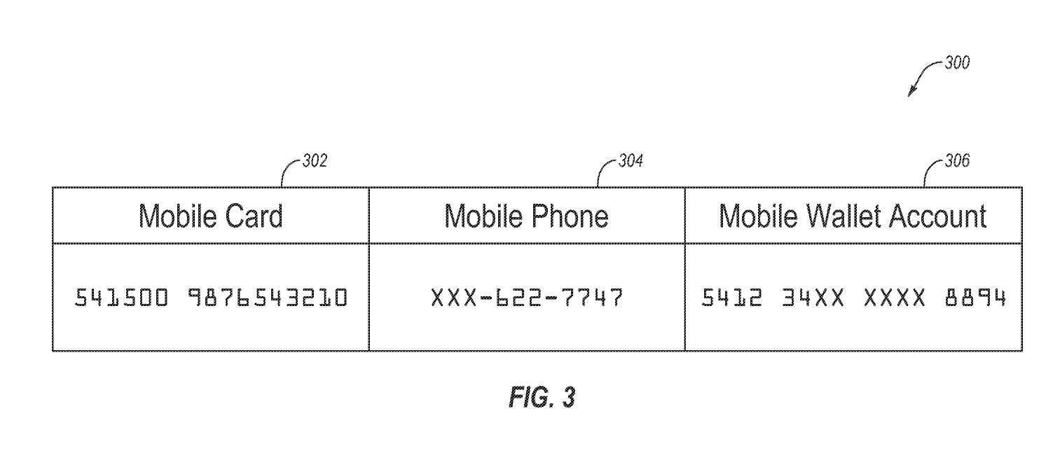

Before being accepted as payment in a POS transaction, the mobile card 102 must be activated by being associated with a mobile phone and a mobile wallet account. For example, FIG. 3 is a chart that illustrates a data record 300 that associates card information 302 of the mobile card 102 with to a mobile phone number 304 of the mobile phone 112 and to a mobile wallet account number 306 of the mobile wallet account 114. The card information 302 of the mobile card 102 includes both a BIN of “541500” and a serial number of “9876543210.” The card information 302 may further include additional routing information. The mobile phone number 304 of the mobile phone 112 is “XXX-622-7747,” where each “X” represents a digit between 0 and 9. The mobile wallet account number 306 of the mobile wallet account 114 is a MasterCard credit card account number of “5412 34XX XXXX 8894,” where each “X” represents a digit between 0 and 9. As noted above, however, other types of accounts could be used in place of the MasterCard credit card account, such as other credit account, deposit accounts, prepaid payment card accounts, and frequent flyer accounts.

The data record 300 disclosed in FIG. 3 may be created in a variety of ways. For example, in the illustrative example introduced above, the authorized user of the mobile phone 112, John Doe, may obtain the mobile card 102 from a dealer of the mobile network employed by the mobile phone 112. For example, where the mobile network employed by the mobile phone 112 is AT&T, as disclosed in FIG. 2A, John Doe may enter a brick and mortar store of an AT&T dealer and request a mobile card. Before issuing the mobile card 102, the AT&T dealer may request that John Doe provide the phone number of his mobile phone and provide an account to use as a mobile wallet account. In response, John Doe may provide the phone number of his existing mobile phone 112, “XXX-622-7747,” and the account number of his existing MasterCard credit card, “5412 34XX XXXX 8894.” The AT&T dealer may then create the data record 300, and make the data record 300 accessible to the mobile network system 110, for example. The data record 300 may be stored in any appropriate information storage device, such as those discussed above. Once the data record 300 is accessible to the mobile network system 110, the mobile card 102 is activated and may be presented as payment in a POS transaction at merchants who are affiliated with the mobile card 102, and the mobile card 102 will be accepted at least if the MasterCard credit card with account number “5412 34XX XXX 8894” has sufficient funds available to cover the transaction amount of the POS transaction.

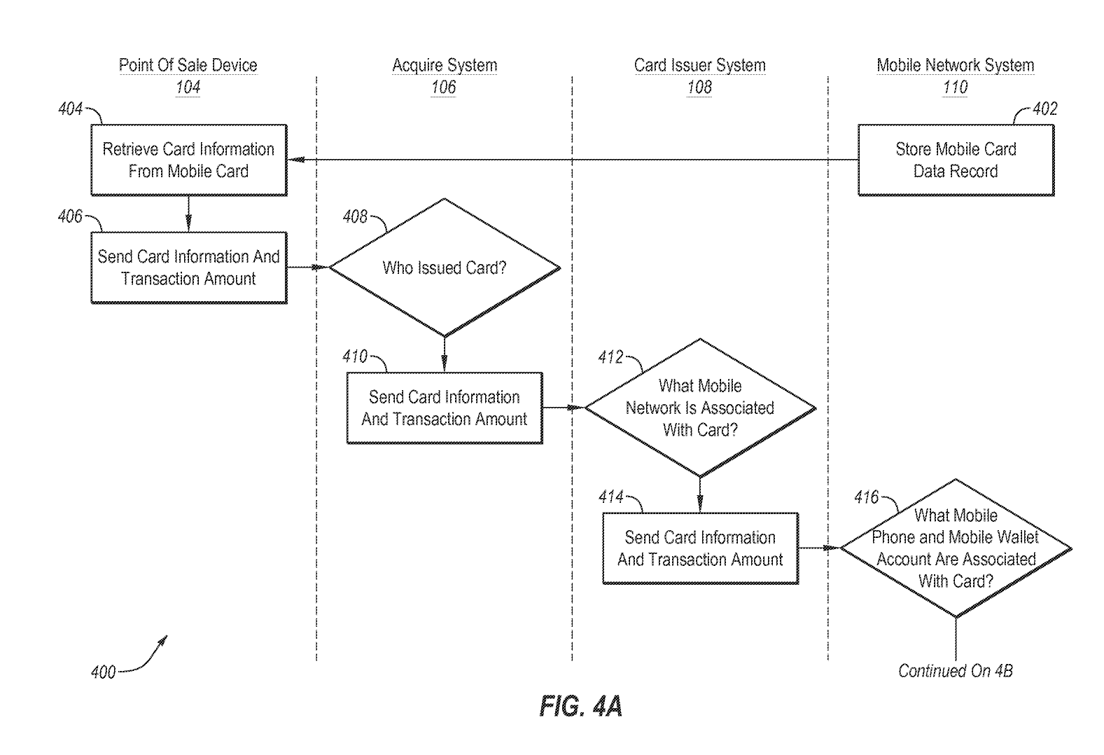

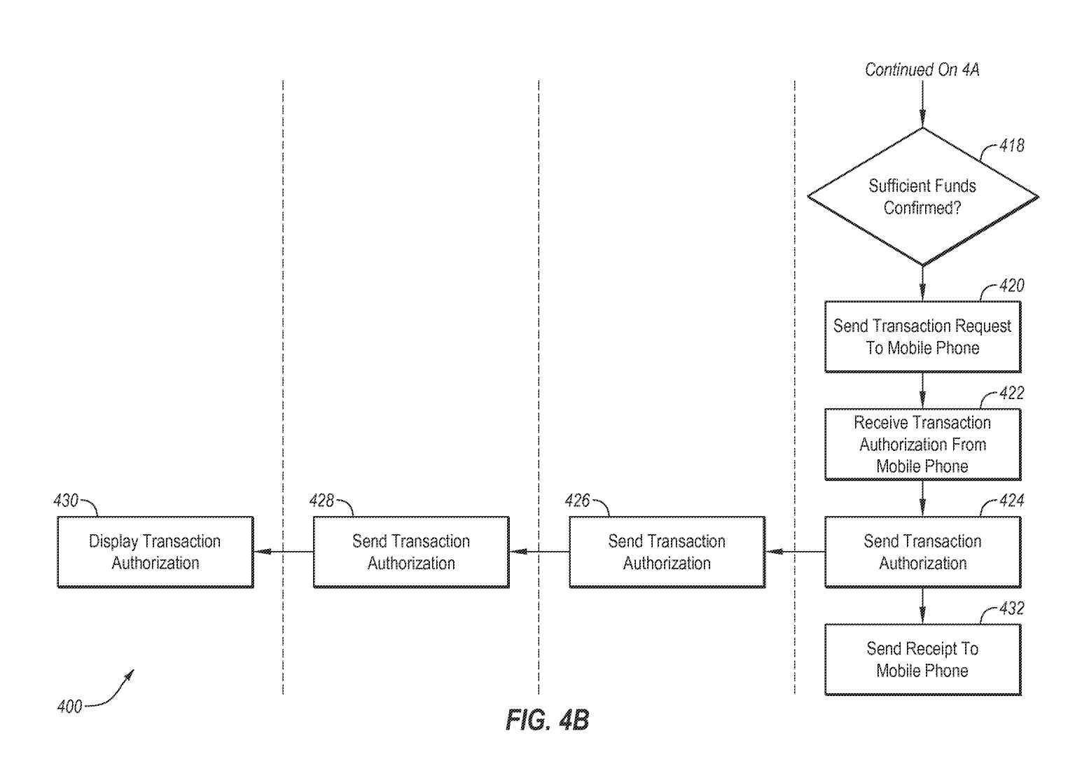

FIGS. 4A and 4B are a flow chart that illustrates a method 400 that may be performed according to some embodiments. The flow chart in FIGS. 4A and 4B and the other figures described herein do not imply a fixed order to the acts or steps, and embodiments of the present invention can be practiced in any order that is practicable. Moreover, the methods may be performed by any of the devices described herein. The method shown in FIG. 4 may be performed, for example, by various components of the system 100 of FIG. 1. Note that the acts or steps of FIGS. 4A and 4B may be performed by different devices. For example, each act or step might be performed by a different device or system. Moreover, any single act or step might be performed by multiple devices or systems.

The method 400 of FIGS. 4A and 4B may begin at 402, where the mobile network system 110 stores a data record 302 that associates the card information 302 of the mobile card 102 with the mobile phone number 304 and with a mobile wallet account number 306. Referring again to the illustrative example introduced above, processing at 402 occurs once Alex Doe presents his mobile phone number and MasterCard credit card account number to the AT&T dealer, who in turn creates the data record 302 and makes the data record 302 accessible to the mobile network system 110. Once 402 has been completed, the mobile card 102 is active and may be presented as payment in a POS transaction at merchants who are affiliated with the mobile card 102

At 404, the POS device 104 retrieves the card information 302 from the mobile card 102. Referring to the illustrative example, processing at 404 occurs once John Doe presents the mobile card 102 as payment for a POS transaction. For example, John Doe has entered a brick and mortar store of a merchant named Benjamin's Shoes and has selected a pair of men's shoes that cost $215.99. John Doe has handed the pair of men's shoes to the cashier at Benjamin's Shoes and has also presented his mobile card 102 as payment for the shoes. The cashier then swipes the magnetic stripe 208 of the mobile card 102 through a magnetic stripe reader of a POS device 104. During the swipe, a magnetic stripe reader of a POS device 104 retrieves the card information 302, and any other available routing information, from the magnetic stripe 208, which includes both the six-digit BIN of “541500” and the ten-digit serial number of “9876543210.” Alternatively, a proximity reader of the POS device 104 may retrieve the card information of the mobile card 102 from RFID IC embedded in the mobile card 102.

At 406, the POS device 104 sends the card information and a transaction amount to the acquirer system 106. Referring to the illustrative example, processing at 406 occurs after swiping the mobile card 102 as the cashier enters the cost of the men's shoes, “$215.99,” as the transaction amount into the POS device 104, or this amount may be automatically entered into the POS device 104 by a related cash register device. The POS device 104 then automatically sends the card information, including the BIN of “541500,” the serial number of “9876543210,” and any available routing information, and the transaction amount of “$215.99” to the acquirer system 106. The acquirer system 106 may be associated with an acquirer with whom Benjamin's Shoes has contracted to provide payment card processing, for example.

At 408, the acquirer system 106 determines which card issuer issued the mobile card 102. Referring to the illustrative example, processing at 408 occurs as the acquirer system 106 examines the card information to determine that the mobile card 106 was issued by the card issuer MasterCard. This determination may be made, for example, by examining any available routing information corresponding to MasterCard that is included in the card information, or by examining a code corresponding to MasterCard that is embedded in the serial number of “9876543210.”

At 410, the acquirer system 106 sends the card information and the transaction amount to the card issuer system 108. Referring to the illustrative example, processing at 408 occurs as the acquirer system 106 sends the card information of the mobile card 102 and the transaction amount of “$215.99” to the card issuer system 108 associated with the card issuer MasterCard. In this case, the card issuer system 108 may be referred to as a MasterCard Directory Server.

At 412, the card issuer system 108 determines which mobile network is associated with the card information 302. Referring to the illustrative example, processing at 412 occurs as the card issuer system 108 examines the BIN of “541500” to determine that the mobile card 106 is associated with the mobile network AT&T. This information may be determined, for example, by a code corresponding to AT&T that is embedded in the BIN of “541500.”

At 414, the card issuer system 108 sends the card information of the mobile card 102 and the transaction amount to the mobile network system 110. Referring to the illustrative example, processing at 412 occurs as the card issuer system 108 sends the card information 302 and the transaction amount of “$215.99” to the mobile network system 110 associated with the mobile network AT&T. The mobile network system 110 may be operated by a service manager of the mobile network AT&T. In this instance, the service manager may properly be referred to as a MasterCard Interface Processor (MIP).

At 416, the mobile network system 110 determines which mobile phone number and which mobile wallet account number is associated with the card information 302. Referring to the illustrative example, processing at 416 occurs as the mobile network system 110 locates the data record 300 using the card information 302 received from the card issuer system 108. Once the data record 300 is located using the card information 302, the mobile network system 110 can determine that the mobile phone having a mobile phone number of “XXX-622-7747” and the mobile wallet account having an account number of “5412 34XX XXXX 8894” are associated with the mobile card information 302.

At 418, the mobile network system 110 determines whether the mobile wallet account associated with the mobile card 102 has sufficient funds to cover a transaction amount of the POS transaction. Referring to the illustrative example, processing at 418 occurs as the mobile network system 110 queries a processor of the MasterCard credit card account having an account number of “5412 34XX XXXX 8894” to determine whether the available funds of the account are greater than or equal to the transaction amount of “$215.99” that was received from the mobile network system 110. If there are insufficient funds available to cover the POS transaction, the transaction may be declined. If there are sufficient funds available, however, the method 400 will proceed to 420.

Although 416 and 418 have been described in connection with the verification of sufficient funds prior to allowing a transaction to be authorized, other embodiments may dispense with this sufficient funds verification for all transactions. Alternatively, some embodiments may dispense with this sufficient funds verification for transactions having transaction amounts below a particular threshold transaction amount, with only transactions amounts at or above the particular threshold amount requiring the sufficient funds verification. The particular threshold amount could be $200, for example. Alternatively, some embodiments may dispense with this sufficient funds verification for transactions on mobile cards in which a backup mobile wallet account is established to handle any transactions where the primary mobile wallet account 114 is subsequently found to have insufficient funds to cover a transaction.

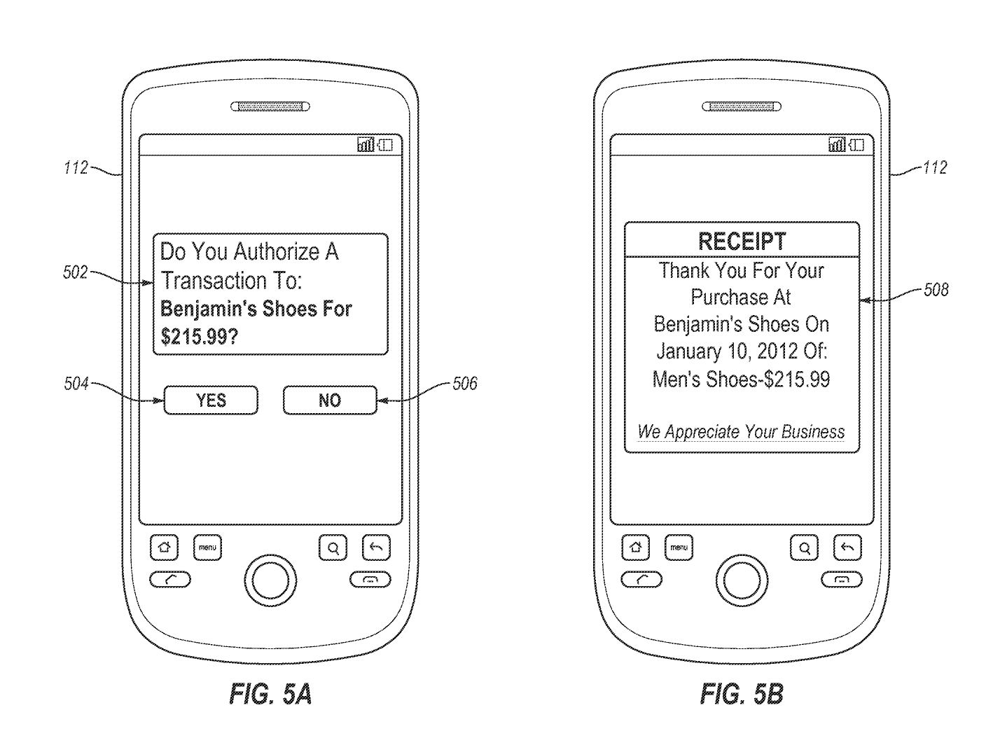

At 420, the mobile network system 110 sends a transaction request to the mobile phone 112. Referring to the illustrative example, processing at 420 occurs as the mobile network system 110 sends a transaction request to the mobile phone 112 requesting that John Doe use his mobile phone 112 to authorize the transaction. For example, FIG. 5A discloses an example embodiment of the mobile phone 112 with a transaction request message 502 presented on a display of the mobile phone 112. The transaction request message 502 may be displayed in a custom mobile phone software application that is associated with the system 100, or may be displayed in a generic mobile phone application such as a SMS messaging application, for example. In the example display of FIG. 5A, the transaction request message 502 is presented along with a “YES” button 504 and a “NO” button 506, thus allowing the user John Doe to choose to either authorize the transaction or deny the transaction. In this example, John Doe is standing at the check-out counter of Benjamin's Shoes and selects the “YES” button 504 on his mobile phone 112 in order to authorize the purchase of the men's shoes.

At 422, the mobile network system 110 receives a transaction authorization from the mobile phone 112. Referring to the illustrative example, processing at 422 occurs as the mobile network system 110 receives a transaction authorization from the mobile phone 112 as a result of John Doe selecting the “YES” button 506 on his mobile phone 112 at 420.

Although 420 and 422 have been described in connection with a simple yes/no authorization request, other embodiments may include an additional layer of security, such as requiring that a user also enter a PIN number in order to authorize the transaction. The PIN number may be stored in the data record 300 at the time that the mobile card 102 is activated, for example. The PIN may help prevent authorization of a transaction where both the mobile card 102 and the mobile phone 112 have been lost or stolen together. The PIN number requirement may be conditioned on the transaction amount, with only amounts above a particular threshold amount requiring the correct entering of the PIN number. Alternatively, the PIN number may be required on all transaction authorizations. The particular threshold amount could be $500, for example, or might vary depending as a percentage of the amount of available funds, such as where the transaction amount is above 50% of available funds.

At 424, 426, and 428, the transaction authorization is sent back along the system 100. In particular, the transaction authorization is sent from the mobile network system 110 to the card issuer system 108 at 424, from the card issuer system 108 to the acquirer system 106 at 426, and from the acquirer system 106 to the POS device 104 at 428. Referring to the illustrative example, processing at 424, 426, and 428 occurs as the transaction authorization received from John Doe at the mobile phone 112 is sent back along the system 100 from the mobile network system 110, to the card issuer system 108, to the acquirer system 106, and finally to the POS device 104.

At 430, the transaction authorization is displayed at the POS device 104. Referring to the illustrative example, processing at 430 occurs as the transaction authorization is received at the POS device 104 and then a corresponding message is displayed on the POS device 104. Upon display of the transaction authorization message, the cashier at Benjamin's Shoes may finalize the transaction by printing a paper receipt of the transaction and give the paper receipt to John Doe, and then handing the men's shoes to John Doe and allowing John Doe to leave the store with his new shoes.

Finally, at 432, the mobile network system 110 may send a receipt of the transaction authorization to the mobile phone 112. Referring to the illustrative example, processing at 432 occurs as the transaction authorization is received at the mobile network system 110 from John Doe, or alternatively after receiving confirmation from the POS device 104 that the transaction was finalized, and a digital receipt is sent from the mobile network system 110 to the mobile phone 112 so that the user John Doe will have a digital receipt of his purchase at Benjamin's Shoes. An example digital receipt 508 is presented example displace of the mobile phone 112 of FIG. 5B. The digital receipt 508 may be sent to the mobile phone 112 and presented to John Doe in addition to, or in lieu of, the cashier at John's Shoes giving John Doe a paper receipt.

It is noted that subsequent to the POS transaction disclosed in the method 400, a settlement will occur where the funds from the mobile wallet account 114 will actually be paid through traditional channels to the merchant who operates the POS device 104.

In this manner, embodiments allow a user to authorize a transaction using a mobile phone after having presented a mobile card as payment for the transaction. In the event that the mobile card is lost or stolen, an unauthorized user of the mobile card will be unable to authorize a transaction using the mobile card unless the unauthorized user also has access to the mobile phone associated with the mobile card. Further, since the account number of the mobile wallet account associated with the mobile card is not displayed on the mobile card, the mobile card can only be used in combination with the mobile phone. Finally, the embodiments disclosed herein allow a user to associate a variety of types of accounts with the mobile card.

Although embodiments have been described in connection with POS transactions, other embodiments may include use of the system 100 in connection with the secure deliver of a virtual primary account number (PAN), CVC 2 code, and expiration date associated with the mobile card 102 that enables a user to present traditional payment card information at a brick-and-mortar merchant or on an eCommerce website on the Internet, for example. Thus, by generating and securing delivering this virtual information to a user, the user can use the mobile phone 112 and the mobile wallet account 114 to process a transaction in a similar manner as when using the mobile card 102.

Finally, it is noted that timeouts on POS transactions may need to be increased above current levels in order to implement the embodiments disclosed herein. For example, in order to allow time for the user to authorize a POS transaction using a mobile phone as disclosed herein, current timeouts on these transactions of ten seconds may need to be increased to timeouts of twenty seconds or higher.

Although the present invention has been described in connection with specific exemplary embodiments, it should be understood that various changes, substitutions, and alterations apparent to those skilled in the art can be made to the disclosed embodiments without departing from the scope of the invention as set forth in the appended claims.

1. A method for operating a processing system, comprising:
determining, by the processing system, that a mobile card has been presented as payment in a point-of-sale (POS) transaction, wherein the mobile card is a physical transaction card;
determining, by the processing system, that a mobile phone is associated with the mobile card;
sending a transaction request to the mobile phone;
receiving a transaction authorization from the mobile phone;
authorizing the POS transaction; and
causing a transaction amount to be paid using a mobile wallet account associated with the mobile phone and the mobile card.

2. The method of claim 1, further comprising:
prior to authorizing the POS transaction, determining that a mobile wallet account associated with the mobile card has sufficient funds to cover the POS transaction.

3. The method of claim 1, wherein determining that a mobile card has been presented as payment in a POS transaction comprises using a POS device to retrieve card information from the mobile card and receiving the card information and a transaction amount sent from the POS device.

4. The method of claim 3, wherein the card information is retrieved from a magnetic stripe on the mobile card.

5. The method of claim 3, wherein the card information is retrieved from a radio frequency identification (RFID) integrated circuit (IC) embedded in the mobile card.

6. The method of claim 3, wherein the card information comprises a bank identification number (BIN) associated with a mobile network and a serial number associated with the mobile card.

7. The method of claim 6, wherein the serial number is visible on the mobile card but the BIN is not visible on the mobile card.

8. The method of claim 3, wherein authorizing the POS transaction comprises sending the transaction authorization to the POS device.

9. A method comprising:
retrieving card information from a mobile card using a POS device, wherein the mobile card is a physical card;
sending the card information and a transaction amount from the POS device to an acquirer system;
determining at the acquirer system that the mobile card was issued by a card issuer;
sending the card information and the transaction amount from the acquirer system to a system of the card issuer;
determining at the card issuer system that the card information is associated with a mobile network;
sending the card information and the transaction amount from the card issuer system to a system of the mobile network;
determining at the mobile network system that the card information is associated with a mobile phone number;
sending a transaction request including the transaction amount from the mobile network system to a mobile phone associated with the mobile phone number; and
sending a transaction authorization from the mobile phone to the mobile network system, from the mobile network system to the card issuer system, from the card issuer system to the acquirer system, and from the acquirer system to the POS device to cause the transaction amount to be paid using a mobile wallet account associated with the mobile phone and the mobile card.

10. The method of claim 9, further comprising:
prior to sending the transaction authorization from the mobile network system to the card issuer system, determining that a mobile wallet account associated with the mobile card has sufficient funds to cover the transaction amount.

11. The method of claim 9, further comprising:
prior to retrieving the card information from the mobile card using the POS device, storing a data record that associates the card information with the mobile phone number and with a mobile wallet account number.

12. The method of claim 11, wherein the mobile wallet account comprises a credit account, a deposit account, a prepaid payment card account, or a frequent flyer account.

13. The method of claim 9, further comprising:
subsequent to sending the transaction authorization from the acquirer system to the POS device, sending a transaction receipt from the mobile network system to the mobile phone associated with the mobile phone number.

14. The method of claim 9, wherein the card information comprises a six-digit bank identification number (BIN) associated with the mobile network and a ten-digit serial number associated with the mobile card, wherein the serial number is visible on the mobile card but the BIN is not visible on the mobile card.

15. A system comprising:
a mobile card configured to store card information, wherein the mobile card is a physical transaction card;
a mobile phone associated with the mobile card;
a POS device configured to retrieve the card information from the mobile card; and
a mobile network system configured to:
determine that the mobile card has been presented as payment in a POS transaction;
determine that the mobile phone is associated with the mobile card;
send a transaction request to the mobile phone;
receive a transaction authorization from the mobile phone;
authorize the POS transaction, and
causing a transaction amount to be paid using a mobile wallet account associated with the mobile phone and the mobile card.

16. The system of claim 15, wherein the card information comprises a bank identification number (BIN) associated with the mobile network and a serial number associated with the mobile card, wherein the serial number is visible on the mobile card but the BIN is not visible on the mobile card.

17. The system of claim 16, wherein a logo of a mobile network associated with the mobile network system is further visible on the mobile card.

18. The system of claim 17, wherein a logo of a card issuer of the mobile card is further visible on the mobile card.

19. The system of claim 15, wherein the mobile network system is further configured to:
store a data record that associates the card information with the mobile phone and with a mobile wallet account.

20. The system of claim 15, wherein the mobile network system is further configured to:
send a transaction receipt to the mobile phone.
